(19) United States
(12) Patent Application Publication
(10) Pub. No.: US 2007/0295277 A1
(43) Pub. Date: Dec. 27, 2007

(54) Remote interactive feeder

(75) Inventors: Allen Kin, Yonghe City (TW); Chen-Hao Chang, Yonghe City (TW)

Correspondence Address: TROXELL LAW OFFICE PLLC, SUITE 1404, 5205 LEESBURG PIKE, FALLS CHURCH, VA, 22041, US

(73) Assignee: Allen Kin, Taipei County (TW)

(21) Appl. No.: 11/473,042

(22) Filed: Jun. 23, 2006

(51) Int. Cl. A01K 39/00

(52) U.S. Cl. 119/51.02

(57) ABSTRACT

When a pet owner is out at a distant place, a pet is fed by a feeding machine in an active way. The pet owner uses a controller to control the feeding machine through a web server. In this way, a time and rationed feeding is done by the remote pet owner.

### FIELD OF THE INVENTION

The pre sent invention relates to a feeding device; more particularly, relates to operating a time and rationed feeding to a pet by a pet raiser at a remote place in an interactive way.

### DESCRIPTION OF THE RELATED ARTS

Raising a pet is very popular now. Yet many people are too busy to feed their pets on time, so they usually put very much food in the food container each time in afraid of making their pets hungry once they are late for the feeding time. But the pets may not finish the food and some are left so that the food may become tainted to harm the pets health.

If the pet owners are going out for a few days and have to leave their pets at home, they may send the pets to pet hotels with quite a sum of money; or they may have some friends to take care of their pets while their friends' lives may be quite bothered. However, either of the above ways may still make them worried about for not seeing their pets directly. Hence, the prior arts do not fulfill users' requests on actual use.

### SUMMARY OF THE INVENTION

The main purpose of the present invention is to operate a time and rationed feeding to a pet by a pet raiser at a remote place in an interactive way.

To achieve the above purpose, the present invention is a remote interactive feeder, comprising an operating device as an operation platform comprising a key set, an image shooter, a display, a microphone unit and a speaker; a web server connected with the operating device; and a feeding device connected with the web server to offer a feeding in an interactive way by receiving a control signal from the operating device. Accordingly, a novel remote interactive feeder is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a structural view showing the preferred embodiment according to the present invention;

FIG. 2 is a perspective view showing the feeding device;

FIG. 3 is a perspective view showing the state of use; and

FIG. 4 is a block view showing the state of use.

### DESCRIPTION OF THE PREFERRED EMBODIMENT

The following description of the preferred embodiment is provided to understand the features and the structures of the present invention.

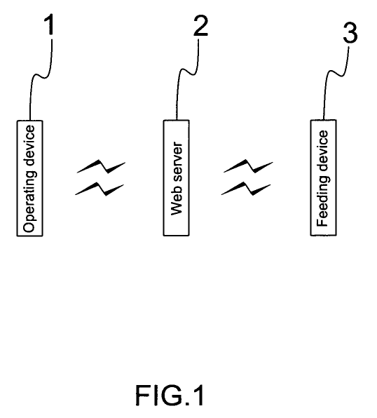

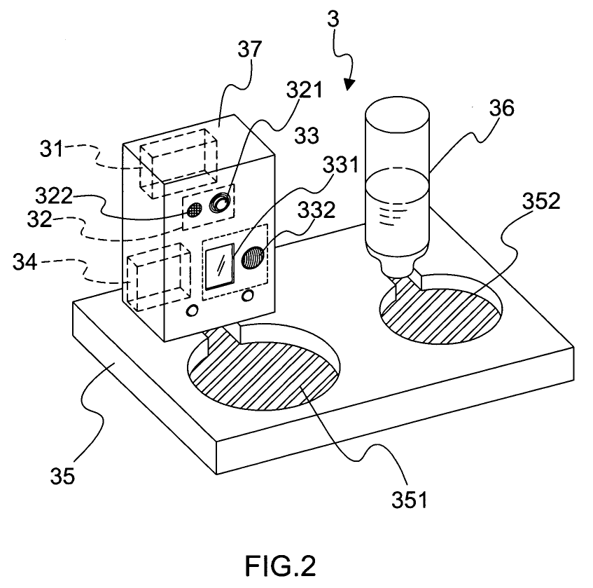

Please refer to FIG. 1 and FIG. 2, which are a structural view showing a preferred embodiment and a perspective view showing a feeder according to the present invention. As shown in the figures, the present invention is a remote interactive feeder, comprising an operating device 1, a web server 2 and a feeding device 3, where a pet is fed with a time and rationed feeding in a remote interactive way.

The operating device 1 is an operation platform for the pet raiser, which is a computer of a desktop computer or a notebook computer, or a mobile electrical device of a mobile phone or a PDA (personal digital assistant).

The web server 2 is connected with the operating device 1.

The feeding device 3 comprises a processor 31, an input unit 32, an output unit 33, a fixed-feed supplier 34, a base 35 and a water supplier 36, where the processor 31, the input unit 32, the output unit 33 and the fixed-feed supplier 34 is located in a case 37; the processor is connected to the input unit 32, the output unit 33, the fixed-feed supplier 34 and the web server 2; the base 35 has at least two containing are as 351,352; a first containing are a 351 is corresponding to the fixed-feed supplier 35 and a second containing are a 352 is corresponding to the water supplier 36; and the input and the output units 32,33 are deposed on a surface of the case 37 corresponding to the first and the second containing are as 351,352. The operating device 1 and the feeding device 3 are connected to the web server 2 through a wiring connection, or through a wireless connection by using a Bluetooth protocol or a WiFi protocol, so that a control signal from the operating device 1 is received for operating an interactive feeding. Thus, a novel remote interactive feeder is obtained.

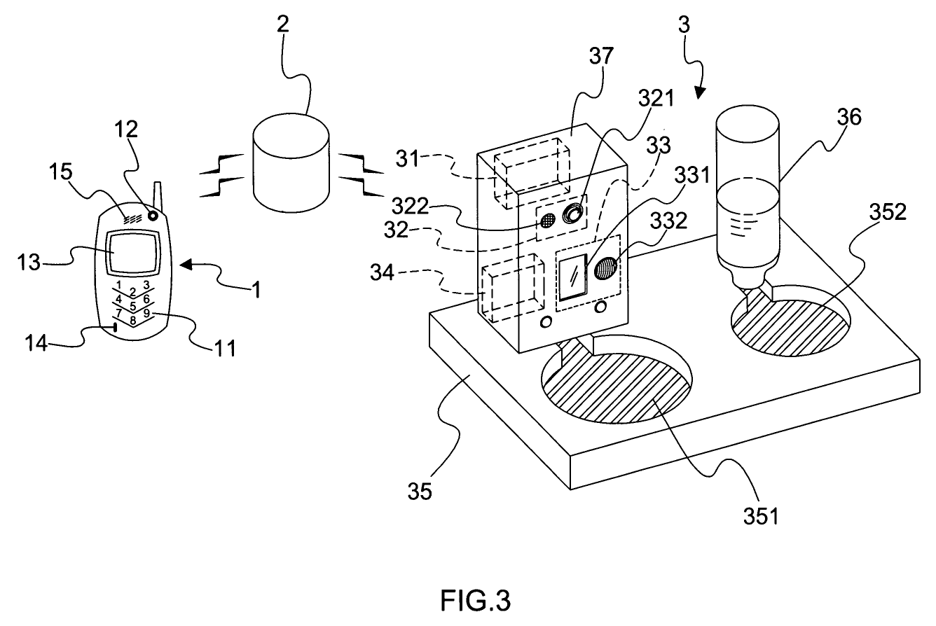

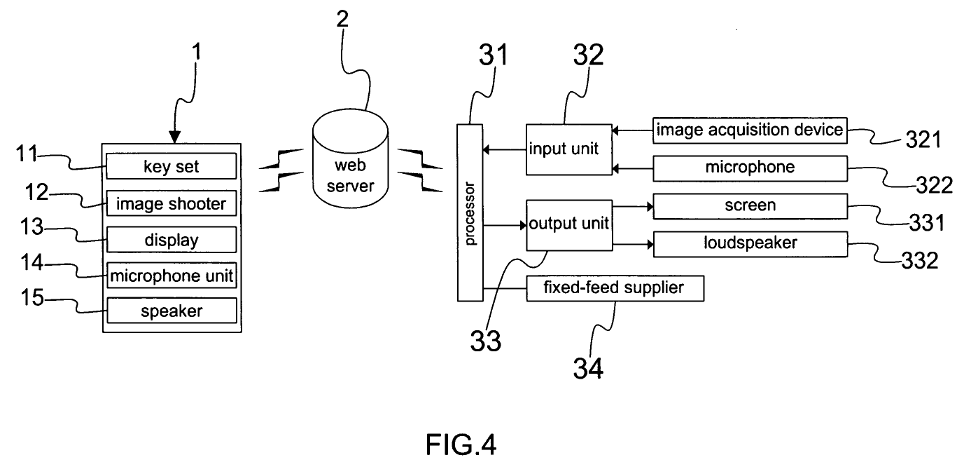

Please refer to FIG. 3 and FIG. 4, which are a perspective view and a block view showing a state of use. As shown in the figure, an operating device 1 of a mobile phone, comprising a key set 11, an image shooter 12, a display 13, a microphone unit 14 and a speaker 15, is used; the operating device 1 and a feeding device 3 are connected to a web server 2 through a wireless connection; an input unit 32 of the feeding device 3 comprises a microphone 322 and a 3G (third-generation) image acquisition device 321 having a high transmission rate; and, an output unit 33 of the feeding device 3 is a set of 3G AV (audio-video) devices including a screen 331 and a loudspeaker 332.

When using the present invention, a pet raiser dials a number through the key set 11 of the operating device 1 to connect to the web server 2 so that the feeding device 3 is linked. The feeding device 3 sends a photo of the specific environment and a sound of a pet to the display 13 and the speaker 15 of the operating device 1 through the image acquisition device 321 and the microphone 322 of the input unit 32. Meanwhile, a photo and a voice of the pet raiser are sent by using the operating device 1 coordinated with the image shooter 12 and the microphone unit 14 through the web server 2 to a processor 31 of the feeding device 3. After being processed, the photo of the pet raiser is displayed on the screen 331 of the output unit 33 and the voice of the pet raiser is sound by the loudspeaker 332 of the output unit 33. Thus, the photo of the environment and the sound of the pet is sent to the operating device 1 through the image acquisition device 321 and the microphone 322 of the input unit 32 so that the pet raiser sees the environment and the status of the pet through the operating device 1; at the same time, the photo and the voice of the pet raiser are displayed and sound on the display 331 and by the loudspeaker 332 of the output unit 33. In this way, the pet is aware of the pet raiser's caring and is noticed of a feeding; and the pet raiser is aware of the status of the pet and feeds the pet at a desired time even at a remote place.

When feeding the pet, the pet raiser uses the operating device 1 coordinated with the web server 2 to sent a control signal to the processor 31 of the feeding device 3. And the processor 31 activates the fixed-feed supplier 34 to supply a feeding in a first containing are a 351 of a base 35 for the pet to eat. At the same time, some water is supplied by a water supplier 36 into a second containing area 351 of the base 35, where the water supplier 36 is a bottle utilizing the atmosphere to keep a water level in the bottle. Thus, the pet raiser controls the feeding device 3 by the operating device 1 through the web server 2 to operate a desired amount of feeding at a desired time even at a remote place.

To sum up, the present invention is a remote interactive feeder, where a feeding device is control led by an operating device through a web server so that a pet raiser operates a time and rationed feeding to a pet at a remote place in an interactive way.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A remote interactive feeder, comprising:
an operating device, said operating device comprising a key set, an image shooter, a display, a microphone unit and a speaker, said operating device being an operation platform used by a pet raiser;
a web server, said web server being connected with said operating device; and
a feeding device, said feeding device being connected with said web server, said feeding device receiving a control signal from said operating device to process an interactive feeding.

2. The feeder according to claim 1,
wherein said operating device is a computer selected from a group consisting of a desktop computer and a notebook computer.

3. The feeder according to claim 1
wherein said operating device is a mobile electrical device selected from a group consisting of a mobile phone and a PDA (personal digital assistant).

4. The feeder according to claim 1,
wherein said operating device is connected with said web server through a wiring connection.

5. The feeder according to claim 1
wherein said operating device is connected with said web server through a wireless connection; and
wherein said wireless connection transmits signals through a protocol selected from a group consisting of a Bluetooth protocol and a WiFi protocol.

6. The feeder according to claim 1,
wherein said feeding device is connected with said web server through a wiring connection.

7. The feeder according to claim 1,
wherein said feeding device is connected with said web server through a wireless connection; and
wherein said wireless connection transmits signals through a protocol selected from a group consisting of a Bluetooth protocol and a WiFi protocol.

8. The feeder according to claim 1,
wherein said feeding device comprises a processor, an input unit, an output unit, a fixed-feed supplier, a water supplier and a
wherein said processor is connected to said input unit, said output unit, said fixed-feed supplier and said web server; and
wherein said base has at least two containing areas, one containing are a corresponding to said fixed-feed supplier, another containing are a corresponding to said water supplier.

9. The feeder according to claim 8,
wherein said processor, said input unit, said output unit and said fixed-feed supplier are located in a case;
wherein said input unit and said output unit are deposed on a surface of said case corresponding to said containing areas; and
wherein said fixed-feed supplier is deposed at an end of said case.

10. The feeder according to claim 8,
wherein said input unit comprises a microphone and a 3G (third-generation) image acquisition device.

11. The feeder according to claim 8,
wherein said output unit is a set of 3G AV (audio-video) devices comprising a screen and a loudspeaker.
